(19) United States
(12) Patent Application Publication
(10) Pub. No.: US 2005/0029440 A1
(43) Pub. Date: Feb. 10, 2005

(54) Machine and method for processing biomolecules

(76) Inventors: Thomas Laurell, Lund (SE); Johan Nilsson, Bjarred (SE); Gyorgy Marko-Varga, Malmo (SE)

Correspondence Address: LADAS & PARRY LLP, 224 SOUTH MICHIGAN AVENUE, SUITE 1200, CHICAGO, IL, 60604, US

(21) Appl. No.: 10/498,212

(22) PCT Filed: Dec. 11, 2002
(86) PCT No.: PCT/SE02/02280

(30) Foreign Application Priority Data
Dec. 11, 2001 (SE) 0104125-0
Jul. 15, 2002 (SE) 0202226-7
Aug. 13, 2002 (SE) 0202416-4

(51) Int. Cl. H01J 49/00; B01D 59/44

(52) U.S. Cl. 250/281

(57) ABSTRACT

A device and method useable for fast processing and depositing of biomolecules. The method includes the following steps: receiving a first set of analytes to be analysed; passing in an array format, analytes through extraction means where said biomolecules adhere to solid phase means; washing said solid phase means with a washing liquid, leaving only said biomolecules; performing elution by passing portions of organic solvent through each said solid phase, forming eluates constituting a second set of analytes containing said biomolecules, as a result of said elution; dispensing, in an array format, said second set of analytes using a micro dispensing array; controlling said array to dispense precise amounts of each one of said second set of analytes on target areas of a target plate.

### FIELD OF INVENTION

The present invention relates to methods and devices for chemical analysis. More specifically it relates to devices for processing biological specimens. Yet more specifically it relates to devices for unattended prepartion of samples containing biomolecules, for example proteins, for subsequent analysis by mass spectrometry using e.g. a matrix assisted laser desorption/ionisation time-of-flight (MALDI-TOF) mass spectrometer.

### BACKGROUND

Chemical analysis and particularly biomolecular analysis of e.g. proteins in a biological specimen are experiencing an increased demand for speed and accuracy. Different techniques for increasing specimen handling time, separation, extraction and preparation of different parts of a specimen have being suggested.

Mass spectrometry involving ionisation by matrix-assisted laser desorption (MALDI) has established itself as a standard procedure for the analysis of biosubstances with large molecules. For this purpose, time-of-flight mass spectrometers (TOF-MS) are usually employed, although Fourier transform ion cyclotron resonance spectrometers (FT-ICR) or quadrupole ion trap mass spectrometers (in short: ion traps) have also been utilised.

In the following, the molecules of biosubstances to be studied will be referred to simply as “analyte molecules” or “biomolecules”. In all cases, analyte molecules are present either in very diluted form in aqueous solutions, pure or mixed with organic solvents. Sometimes these analytical solutions are very complex and contain a high degree of impurities with respect to the requirements of the analytical procedures, e.g., in the case of body fluids.

The biosubstances include all biopolymers as well as results of said biopolymers interaction with other molecules. “Biopolymers” comprise oligonucleotides (i.e. fragments of genetic material in various forms such as DNA or RNA), peptides, polysaccharides and proteins (the essential building blocks of the living world) as well as their special analogues and conjugates such as glycoproteins or lipoproteins, and peptides arising from the action of digestive enzymes.

The selection of matrix substance for MALDI depends on the type of analyte molecule; more than a hundred different matrix substances are known and used today. One of The tasks of the matrix substances include to isolate the analyte molecules from each other wherever possible and bind them to the sample carrier plate, to transfer the molecules into the vapor phase by forming a vapor cloud during the laser bombardment, and ultimately to ionise the biomolecules by protonation or deprotonation, i.e., to add or remove one or more protons. For this task it has proven useful to incorporate the analyte molecules individually in the crystals of the matrix substances during their crystallisation, or at least to finely distribute them in the boundary areas between the crystals. Here it seems important to separate the analyte molecules from each other, i.e., no clusters of analyte molecules should be allowed in the prepared matrix crystal sample.

A variety of procedures are known for applying analytes and matrices. The simplest of these entails the pipetting of a solution containing both analyte and matrix onto a cleaned, metallic sample support. The drop of solution wets a certain area of the metal surface (or its oxide layer) whose size on hydrophilic surfaces is many times larger than that of the diameter of a drop. The size depends on the hydrophilicity and the microstructuring of the metal surface as well as on the properties of the droplet, in particular that of the solvent. After drying of the solution, a sample spot consisting of small matrix crystals forms that is the same size as that of the originally wetted surface area. The matrix crystals are usually not uniformly distributed throughout the formerly wetted area As a rule, crystals of the matrix start growing at the inner margin of the wetting surface on the metal plate. They then grow towards the interior of the wetting surface. They often form thin needle crystals, as is the case for example for the frequently used matrices 5-dihydroxybenzoic acid (DHB) or 3-hydroxypicolinic acid (HPA), which often stand out from the carrier plate at the interior of the spot. The centre of the spot is frequently empty or covered with fine crystals, although often they cannot be used for MALDI ionisation because of their high concentration of alkaline salts. The loading of the crystals with biomolecules is also very uneven. This type of loading therefore requires viewing of the sample carrier surface during MALDI ionisation by a video microscope which can be found in any commercially available mass spectrometer used for this type of analysis. Ion yield and mass resolution vary in the sample spot from place to place. It is often an arduous process to find a suitable position on the sample spot with a satisfactory analyte ion yield and mass resolution, and only experience, trial and error allow for improvements.

Although there are control programs for mass spectrometers with algorithms for automatically seeking the best spots for MALDI-ionisation, such procedures, involving many attempts and evaluations, are necessarily very slow.

With other loading procedures the matrix substance is already present on the carrier plate before application of the solvent droplets, which now only contain analyte molecules.

If the surface of the sample carrier plate is not hydrophilic, but hydrophobic, smaller crystal conglomerates are formed, but the droplets tend to wander in an uncontrollable manner during drying. Hence the localisation of the crystal conglomerates cannot be predicted and must be sought during the MALDI process. Furthermore, there is a considerable risk that droplets will conglomerate and thus render a separate analysis of samples impossible.

Biosample analyses are now performed in their thousands, a situation which demands automatic high throughput procedures. A visual control or search, or even an automated search, would obstruct such a high throughput procedure.

Recent prior art includes a procedure which leads to local and size-defined crystallisation fields on small hydrophilic anchor regions of 100 to 800 micrometer in diameter within an otherwise hydrophobic surface (DE 197 54 978 C2). The aqueous drops are fixed by the hydrophilic anchors and prevented from wandering even when they initially rest on surrounding lyophobic areas. During drying the droplets withdraw onto the anchor, and relatively dense, homogeneously distributed, crystalline conglomerates arise on the exact position of these anchors (sometimes even structured as a single compact crystalline block depending on the type and concentration of matrix substance). It could be shown that the detection limit for analyte molecules improves with reduction of the surface area of the wetting surface. Thus, smaller quantities of analytes and more diluted solutions can be worked with during sample preparation; such an advantage is expressed in better running biochemical preparatory procedures and reductions in chemical material costs. With a suitable preparation the analytical sensitivity over the surface of the sample is highly uniform. Thus the ionisation process can be freed from the need to perform visual or automated searches for favorable sites; instead a “blind” bombardment of the crystal conglomerates with desorbing laser light can be used. This preparation method for prelocated spots of equal sensitivity accelerates the analytical process.

The crystal conglomerates forming on the hydrophilic anchor surfaces reveal a microcrystalline structure suitable for the MALDI-process. As the speed of the drying process is increased, the crystalline structure becomes finer.

Here a “hydrophobic” surface is understood as a water repellant surface, i.e. one resistant to wetting by aqueous solutions. Correspondingly, a “hydrophilic” surface is understood as one that can be easily wetted by water. “Oleophobic” and “oleophilic” (also referred to sometimes as “lipophobic” and “lipophilic”) refer to surfaces which repel or which can be wetted by oil, respectively. Organic solvents that are not miscible with water usually have an oily nature in this meaning of wettability, i.e. they can wet oleophilic faces. They are as a rule miscible with oil. Organic solvents that are miscible with water, e.g. methanol, acetone or acetonitrile, can wet both oleophilic and hydrophilic surfaces in a pure state. However, the wettability of oleophilic surfaces reduces as the water content increases.

For a long time it has been the opinion that hydrophobic surfaces are always also oleophilic, and that oleophobic surfaces are always hydrophilic. However, for some years it has been known that surfaces exist which are both hydrophobic and oleophobic; these include smooth surfaces of perfluorinated hydrocarbons such as polytetrafluoroethylene (PTFE). Such surfaces are designated here as “lyophobic”, a term which has been adopted from colloidal science.

Recently, it has also become known that the wetting or liquid repelling character of a surface strongly depends on its microstructure. An example of this is the so called “lotus effect” (named after the lotus-plant).

The hydrophobicity (oleophobicity, lyophobicity) can be measured essentially by measuring the contact angle which the liquid develops under standardized conditions at the edge of the wetting surface with the solid surface. In an absolute sense a surface of a material is referred to as hydrophobic, oleophobic or lyophobic if the contact angle of the respective liquid level in a capillary constructed from this material is more than 90 degrees. Such a definition is hard to apply to the contact angle of a droplet sitting on a flat surface since the droplet size actually plays a bigger role in this case. In the following, the terms hydrophilic and hydrophobic are not used in an absolute, but rather a relative sense: a surface is more hydrophobic towards a liquid than another surface if the contact angle is larger. In general, a surface is already regarded as hydrophobic if the contact angle is smaller than 90 degrees, but a drop does not run on the surface to form a large wetting surface.

A surface is particularly designated as “hydrophobic” when a drop retracts on a surface during drying or aspiration with a pipette, reducing the wetted surface reduces in size and leaving behind a dry surface (so called “dynamic hydrophobia”).

As a rule, biomolecules are best dissolved in water, sometimes with the addition of organic, water-soluble solvents such as alcohols, acetone or acetonitrile. The analytical solutions of biomolecules sometimes also contain other substances such as glycols, glue-like buffering agents, salts, acids or bases depending on their preparation. The MALDI process is disrupted considerably by the presence of these impurities, sometimes through prevention of protonation, and sometimes through the formation of adducts. In particular, alkali ions often form adducts with analyte molecules of varying size and prevent any precise mass determination. The concentration of alkali ions in the sample preparation, as well as the concentration of other impurity substances must be kept extremely low by careful purification procedures.

For purification and simultaneous enrichment of biomolecules one can use so-called affinity adsorption media similar to those used in affinity chromatography. While in affinity chromatography one uses highly bioselective affinity adsorbents, for the purification of initially unknown mixtures of biopolymers without losses of special types of biomolecules one needs non-specific adsorbents that can bind all biomolecular constituents of the mixture to as near a similar degree as possible.

For purification of peptides, proteins or DNA mixtures, sponge-like microspheres of adsorbent material (such as POROS, a registered trademark by Applied Biosystems, Inc.), pipette tips filled with sponge-like adsorbent (such as ZIPTIPs, a registered trademark of Millipore Corporation) or C18 coated magnetized spheres (such as GenoPure, a product of Bruker Daltonics, Inc.) have proven particularly useful until now. These materials are all strongly oleophilic and bind peptides or oligonucleotides via hydrophobic bonds. As a rule, biomolecules can be eluted using aqueous methanol or acetonitrile solutions, and elution can often be assisted by altering the pH-value. However, purification with these materials is labor-intensive since it requires additional materials and additional procedural steps.

### SUMMARY

The object of the present invention is to provide a device and a method for analysis of biopolymers, and with the more specific object to provide such a device and method especially suitable for analysis of proteins in a multitude of small volume samples.

It is an objective to reduce the processing time for an analysis by reducing the amount of arduous manual interaction. It is an goal to provide a device capable of processing a sample in less than four hours. It is also an objective to minimise volume flows, and the amount of biopolymer needed to establish a reliable analysis result It is also further an objective to speed up enzymatic and other reaction times by working in microscopic volumes and at suitable temperatures. A typical input to the machine is one or more protein samples, and a typical output from the machine is a MALDI target plate provided with high density protein spots. Many of these objects and objectives mentioned are reached by applying microstructures and micromachining techniques and by applying automatics and robotics for performing most steps in the analysis process.

Before entering a preferred embodiment of a device according to the invention the protein samples are handled by biochemical and chemical pre-treatment in order to make the three dimensional structure of the protein unfold and accessible to enzymatic cleavage, resulting in a peptide composition corresponding to the protein. All of these wet-lab experimental parts are performed by robotics. The first interface occurs in-between the sample introduction into a protein analysis machine according to an embodiment of the invention. Sample introducution can be performed in parallel for a number of parallely running process lines.

The samples are thus transferred to the protein analysis machine inside which machine a fully automated handling of the sample is made. Sample preparation by simultaneous enrichment of the sample and elimination of interfering components present therein is accomplished. In this way a pure sample is retained on the solid-phase of e.g. a micro-extraction bed of a dispenser cell element. A sample volume has in this way been 10-1000-fold enriched whereby the sample upon analysis generates an amplification in the final signal read-out of the analysis.

The second interface occurs in-between the sample elution from the micro-extraction bed in the protein analysis machine onto a target plate on whereto the sample is deposited.

The entire process operation can be controlled in an unattended mode by a fully automated operation of the protein analysis machine. The logistics and the process cycle is controlled by robotic software.

Preferred embodiments of the invention advantageously include one or more dockable microextraction chip units, methods for single sample processing (not array dispensing), and arrays for use by chemical agent for biochemical analysis.

### FIGURES

The invention is disclosed in the following description and described with the aid of the following figures in which

FIG. 1 a shows a flowchart of process steps for at protein analysis platform

FIG. 1b shows a combined device comprising an extractor array and a dispenser array.

FIG. 1c shows in cross section the dispenser array and the beneath arranged target plate

FIGS. 2a and b show a dockable extractor according to an embodiment of the invention.

FIG. 3 illustrates the process of extracting (I), washing (II) and eluating and dispensing (III)

FIG. 4 shows an alternative embodiment of a dockable extractor and how it is docked

FIGS. 5a and b shows an alternative embodiment of the combined device of FIG. 1.

FIG. 6 shows a dockable extractor (extractor cartridge) comprising multiple extractors and bending notches.

FIG. 7a shows a view from above of an embodiment of the dockable microextraction chip of the “”2D-Array” type, together with a cross section of the same.

FIG. 7b shows a view from above of an embodiment of the dockable microextraction chip of the “Film-strip” type.

FIG. 8 shows a view from above of an embodiment of the dockable microextraction chip arranged at a circular disc, together with a detail.

FIG. 9 shows angular views illustrating the steps of using film-strip and circular embodiments for loading, extracting, and eluating/dispensing samples.

FIG. 10a shows a side cross section of an embodiment having a droplet inlet zone

FIG. 10b shows a view from above of the embodiment in FIG. 10a

FIG. 11 shows a schematic cross section of an electrospray nozzle and power source

FIG. 12a shows a cross sectional view from the side of a combined extractor and dispenser

FIGS. 12b and c shows two alternative embodiments of means for preventing extraction beads to escape from the extractor

FIG. 13 a and b show details of a third alternative embodiment for preventing extraction beads to escape from the extractor.

### DESCRIPTION

Method

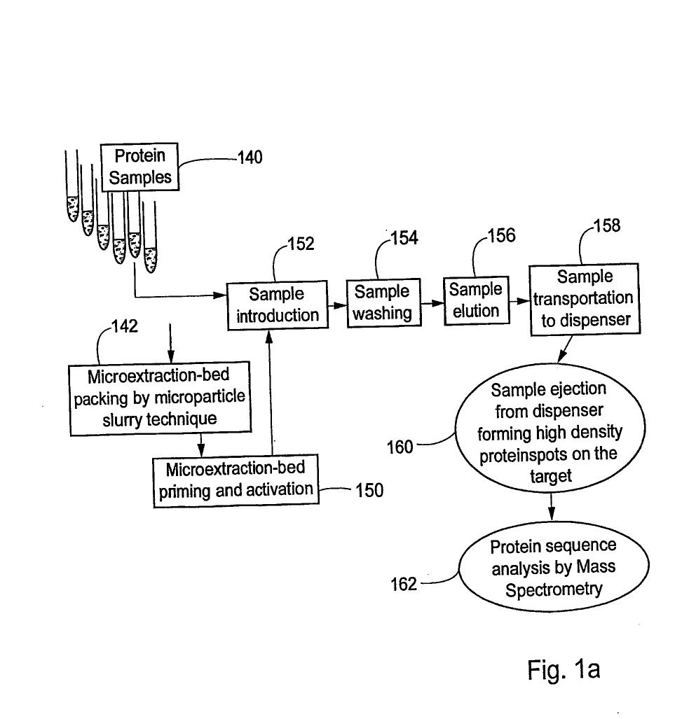

Referring to FIG. 1, embodiments of a method according to the invention includes that protein samples are introduced in the analysis machine. The protein samples can be generated from several different biological sources. Samples are pre-separated prior to introduction into the analytical platform by for instance separation by the following techniques, but not limited to;
one-dimensional gel electrophoresis
two-dimensional gel electrophoresis
single dimensional liquid chromatography
multidimensional chromatography
capillary electrophoresis
ultra membrane filtration
Dialysis
Affinity probe isolation

Analytes in the sample is typically present in microenvironments that holds interferents to the protein sequencing analysis why an optimal sample preparation protocol is a pre-requirement in order to generate high quality protein identifications by means of protein sequencing using mass spectrometry. The samples will be intact proteins in solution, or digested proteins in their peptide fingerprint forms in solution. A typical embodiment comprises the following steps:

1/The micro extraction bed will be activated 150 prior to sample introduction by flushing through 2 ml of acidic water, 2 ml of acetonitril/water and finished by flushing 2 ml of acidic water.

2/The samples 140 will be diluted by appropriate eluent modifiers, or introduced 152 directly into the pre-activated flow-through micro-extraction bed positioned in the piezo-dispencer cell, i.e., the dispenser. Typically sample volumes range in-between 1-500 μl.

3/The micro extraction bed with the bound and enriched protein(s) will be washed 154 using 2 ml of acidic water, thereby eliminating a lot of interferents from the sample matrix.

4/Next the enriched protein(s) will be eluted 156 by using 0.5-5.0 μl ml of acetonitril/formic acid (2%) at an organic modifier ratio of 60:30.

5/A continuous flow will transport 158 the protein sample to the orifice of the piezodipencer cell.

6/The sample is ejected as discrete droplets forming high density protein spots on the target plate.

Another embodiment of a method according to the invention includes the following steps:

Receiving a specimen to be analysed;
transporting said specimen to a separation means;
separating said specimen into (a first set of) fractions;
passing each one of said fractions through extraction means where proteins adhere to solid face means;
passing specimen to extraction means where proteins adhere to solid face means;
washing said solid face means with a washing liquid, leaving only said proteins;
performing elution by passing portions of organic solvent through each said solid phase, forming eluates constituting a second set of fractions containing said proteins, as a result of said elution;
conducting each one of said second set of fractions to a micro dispensing array;
dispensing precise amounts of each one of said second set of fractions on target areas of a target plate, using a piezoelectric array or an electrospray array for dispensing;
controlling the time between dispensing droplets from the dispenser;
controlling the temperature of the plate and the the surroundings thereof,
digesting said proteins into peptides by means of digestive enzymes being placed in the target areas;
mechanically moving the target plate so that a new row of target areas becomes available to the dispenser array;
mechanically moving the receiving plate to a mass spectrometer means;
performing mass spectrometry on each target area of the receiving plate, measuring peptide signatures;
recording said peptide signatures;
matching said measured peptide signatures to a library of peptide signatures for known proteins for determining the presence and content of different proteins in each target area FIGS. 1b and c show a device suitable for performing enrichment operations on a mixture of protein molecules.
   Extractor

Referring to FIGS. 1b and 1c a second portion 120 of a device according to the invention is suitable for said enrichment. Said portion 120 comprises a number of separate conduits or channels 101, each containing a porous bed (not shown in FIG. 1b or 1c), able to adsorb species from the one of the components of said mixture that is brought to pass through it. Said bed can comprise e.g. a bed of microscopic beads. The dimensions of the channels are microscopic. The width of a channel is typically less than a tenth of a millimeter, often even smaller. The depth of a channel is in this magnitude too.

As an alternative the porous bed can be omitted and the function to adsorb species to be analysed can be carried out by means of porous walls/surfaces of the channels/conduits.

In a methodological step the adsorbed species is eluted by the aid of an elutant forming an eluate for each component, i.e. a type of solid phase extraction, SPE.

In FIG. 1b is shown an integrated dispenser portion 130 arranged in direct fluid connection with the channels 101 of the extractor portion 120. The dispenser portion 130 comprises an array of dispenser basins 132 each provided with a dispenser nozzle opening 134 and optionally with an outlet opening (not shown), providing a flow-through means useable e.g. for washing the device efficiently without having to feed all washing fluid through the dispenser nozzle. In FIG. 1c is shown dispenser basins 132 and dispenser nozzle openings 134 in cross section, together with an arranged target plate, suitable for receiving ejected droplets 138.

Dockable Extractor

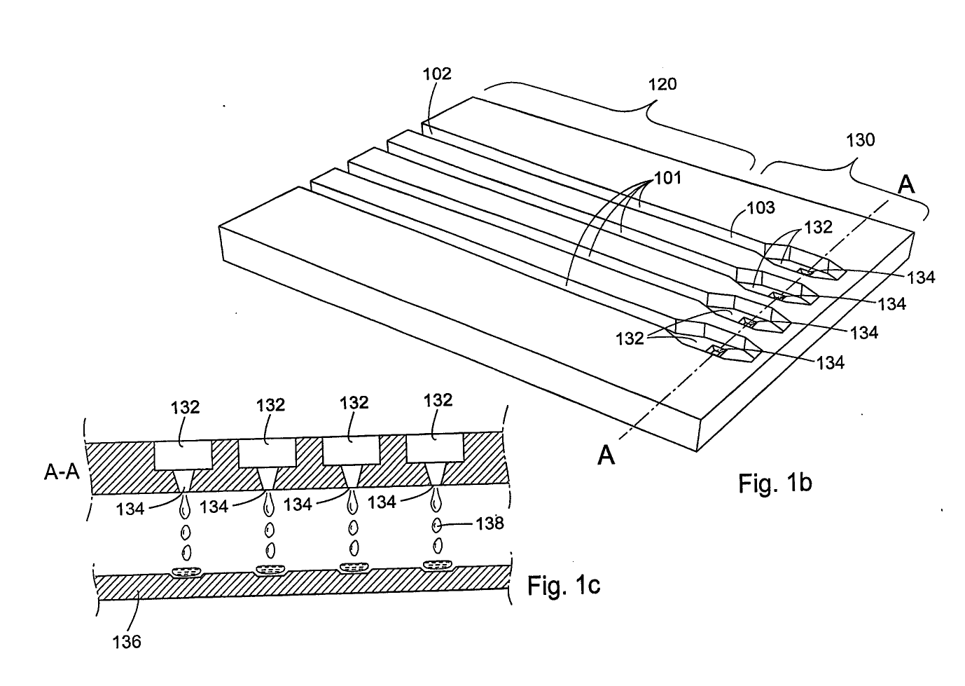

Referring to FIG. 2, an alternative embodiment a portion of the device, also called an extractor 207, is designed to be dockable. With this term is meant that said extractor comprises a plate, chip unit or another movable entity housing channels 111 with the porous bed 201/porous walls/surfaces and is devised to be made manually or automatically attachable/detachable and making a temporary fluid connection to and from other devices 230 or parts of the analysis device. Said extractor 207 is also designed to be re-attachable to the same or other parts of the analysis device, such as a washing device or a dispensing device. Specifically such embodiments comprises docking means 205 that enables the docking and the flow of liquid from other parts of the analysis device to the inlets of extractor, and the flow of liquid from outlets of the extractor to other portions of the analysis device. Such portions may include feeding device, washing device and elution device.

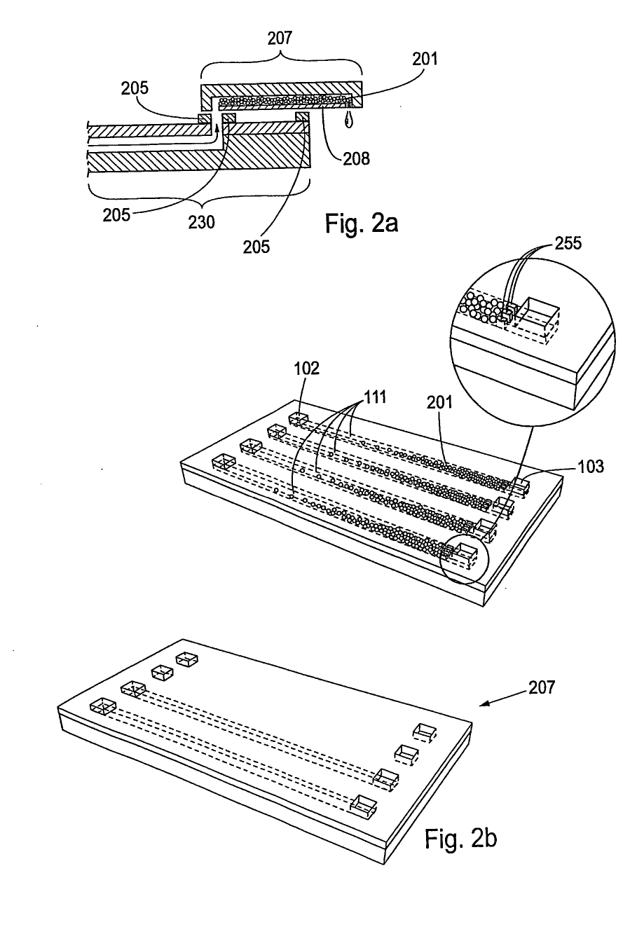

FIG. 3 shows how the dockable extractor 207 is used for introduction of sample (I), for washing (II) and for elution and dispensing of sample (III). The array dispenser 301 comprises an array of dispenser units each dispenser unit comprises an inlet 313 a basin 310 in fluid connection with the inlet 313 and with an outlet 314 and with a dispenser nozzle 307 having a dispenser nozzle opening 308. The basin 310 is defined partly by a flexible membrane 315 having mechanical contact with an actuator element 320 such that the pressure in the basin 310 can be quickly raised ejecting a droplet of analyte fluid through the dispenser nozzle opening 308 towards a target plate 340.

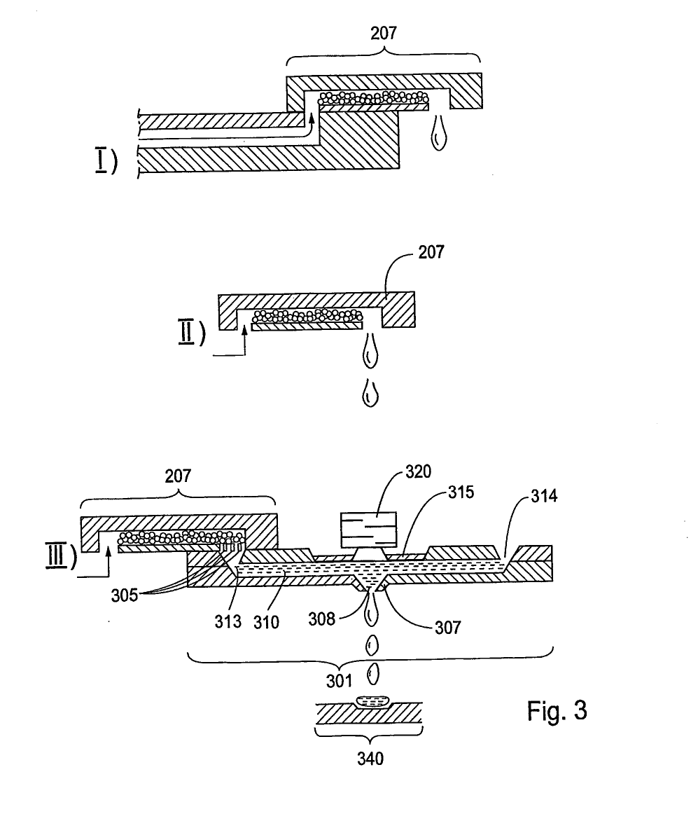

FIG. 4 shows an alternative embodiment of a dockable extractor 407, when it is used in the steps of introduction of sample (I), washing (II) and elution and dispensing (III).

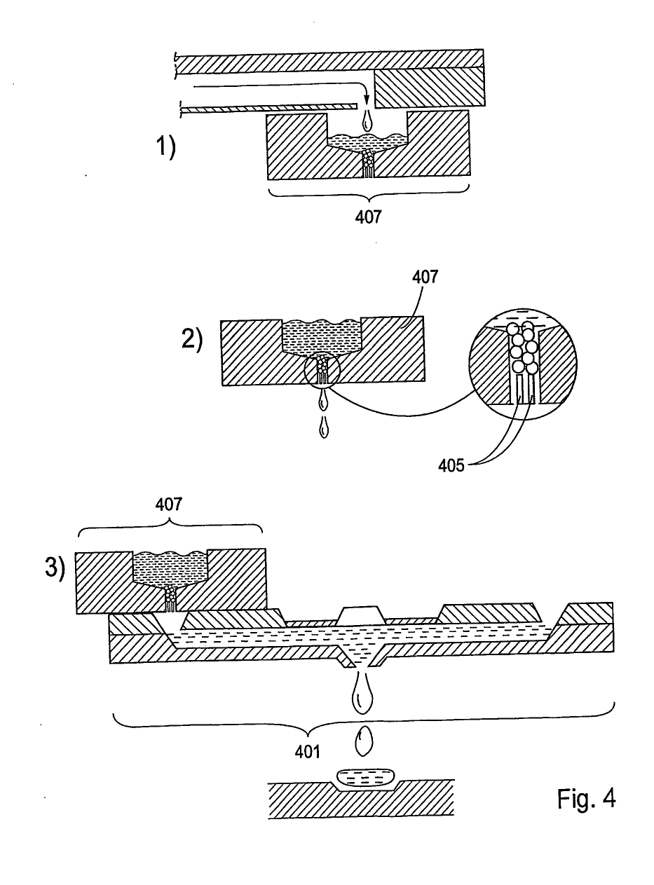

FIG. 5 shows a device with integrated extraction and dispensing means. Similar to the device described in FIG. 1 there are a number of extractor channels 527 arranged between a number of separating walls 521-525. Different from the device described in FIG. 1, a dispenser portion 540 comprises one common basin 510. The flow of eluant to each dispenser nozzle opening 501-506 is kept from mixing with adjacent flows by laminar flow, i.e. due to the microscopic dimensions and laminar flow characteristics and the fact that there is arranged a certain distance between nozzle openings, and said nozzle openings are arranged mainly in the middle of a laminar flow lamina, analyte flowing from a specific extractor channel 527 will be handled by one specific dispenser nozzle opening 501-506 only.

Dockable Extractor Cartridge

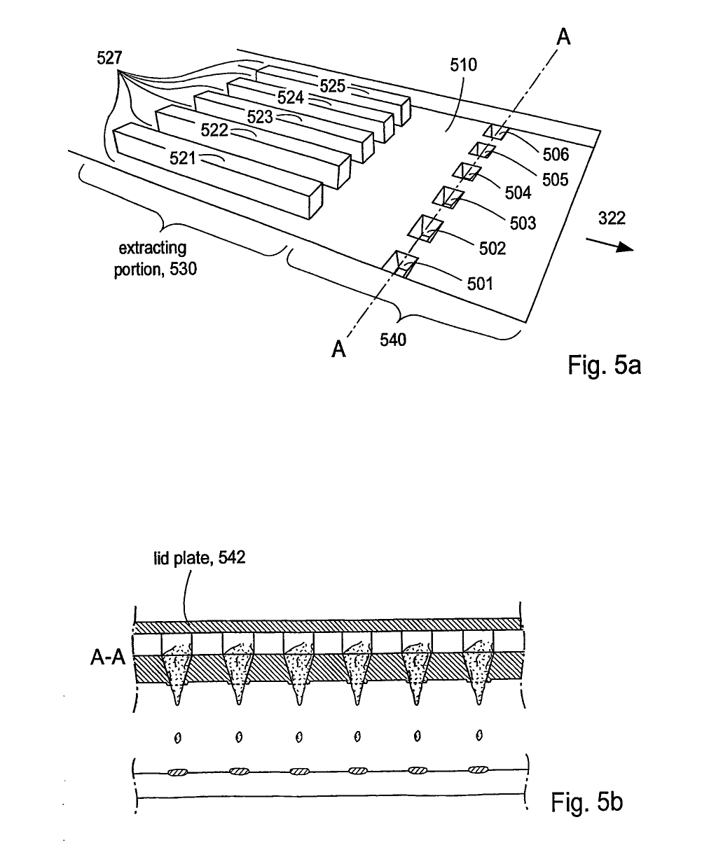

In an alternative embodiment of the dockable extractor, see FIG. 6, an extractor cartridge comprises notches separating a number of extractor arrays. By bending the cartridge at the notches the separate arrays can dock to a dispenser array, because the preceding extractor array is bent upwards, leaving space available for the next extractor array.

Droplet Capillary Loading, Filter Paper Drainage

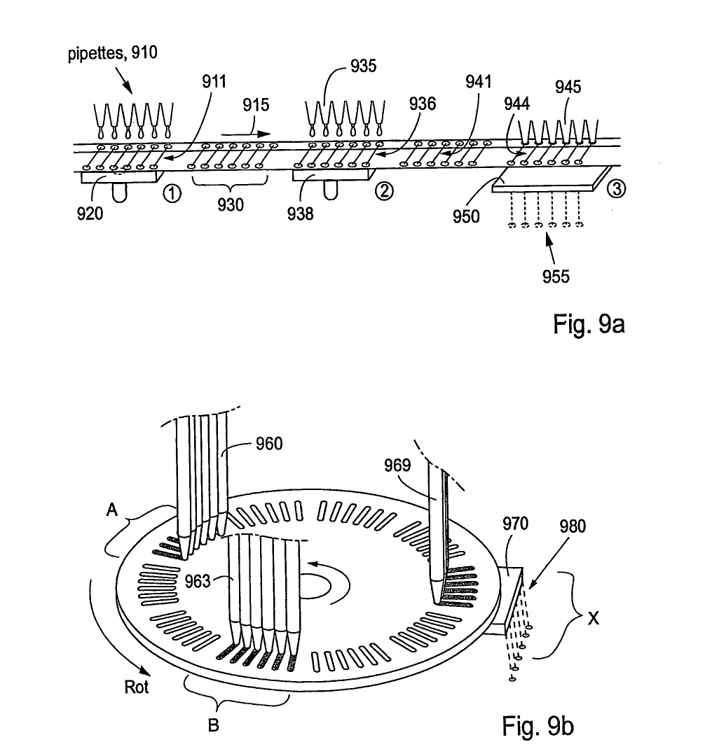

Referring to FIG. 10, supplying analyte solution to an extractor according to an embodiment of the invention, is performed by pipetting a droplet of said solution in a droplet inlet zone 1010, said zone having a direct fluid connection 1020 to the extractor bed. Capillary forces will subsequently fill the extractor because of the small dimensions of the channels of the extractor. Fluid is then drained through the extractor by applying a filter paper at the outlet 1030, said paper having suitable capillary characteristics for draining all the fluid through the extractor, leaving no remains of the droplet at the droplet inlet zone or any greater amounts of fluid inside the extractor. The same procedure of droplet loading and filter paper drainage can be used for washing and elution.

Typically a droplet of 50 microlitres is pipetted in a droplet inlet zone 3 by 3 millimetres and 300 micrometres deep.

Multiple Microextractor Assemblies

In alternative embodiments of the dockable extractor, see FIG. 6, 7, 8, and 9, an extractor assembly is devised that comprises a multitude of extractor arrays providing an “assembly line” for efficient and robotised fast handling of extractor modules:

Straight Linked Chain

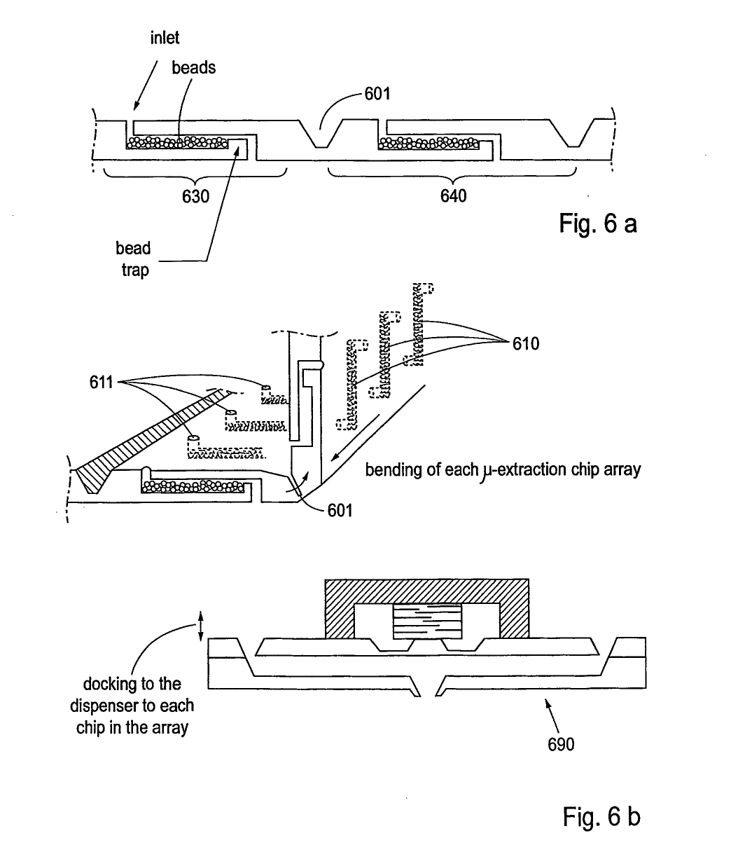

In one of these alternative embodiments of the dockable extractor, see FIG. 6 and FIG. 7a, a linked chain extractor-assembly comprises a multitude of extractor arrays 630, 640 etc parallel to a long axis of the chain and orthogonally running notches 601 separating one extractor array from another. Each extractor array comprises a number of extractor channels 610, 611. By bending the cartridge at a certain notch one of the separate arrays are enabled to dock to e.g. a following dispenser array 690, because the preceding extractor arrays is bent upwards, leaving space available for the next extractor array. Bending at another notch enables another array to dock to said dispenser array 690.

Orthogonally Linked Chain (Film-Strip)

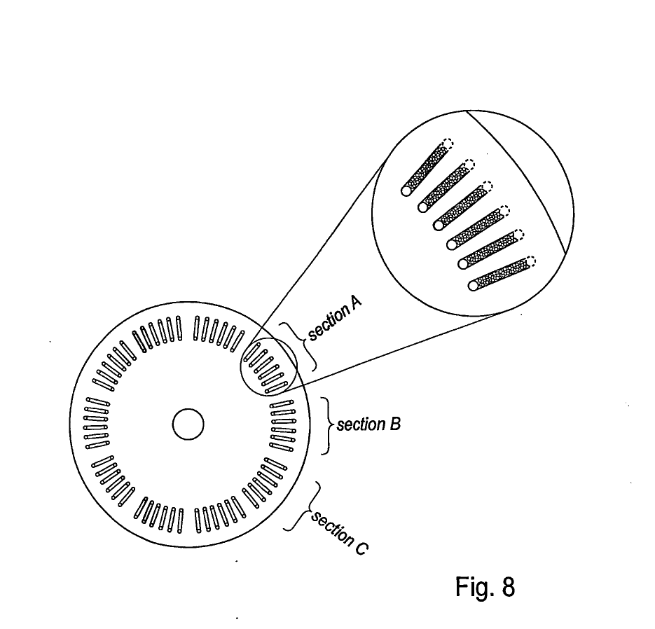

In FIG. 7b is shown an orthogonally linked chain extractor-assembly comprising a multitude of extractor arrays, also called sections, orthogonally running compared to a long axis LA of the chain. Said orthogonally linked chain provides docking surfaces 710, 720 at the long sides of the chain, providing for easy access to many microextraction arrays simultaneously. FIG. 9 shows pipettes 910 arranged to supply analytes to extraction arrays 930 devised to move along a type of “assembly line” handling device, implementing a processing method as described below.

Disk Unit (Circular Arrangement)

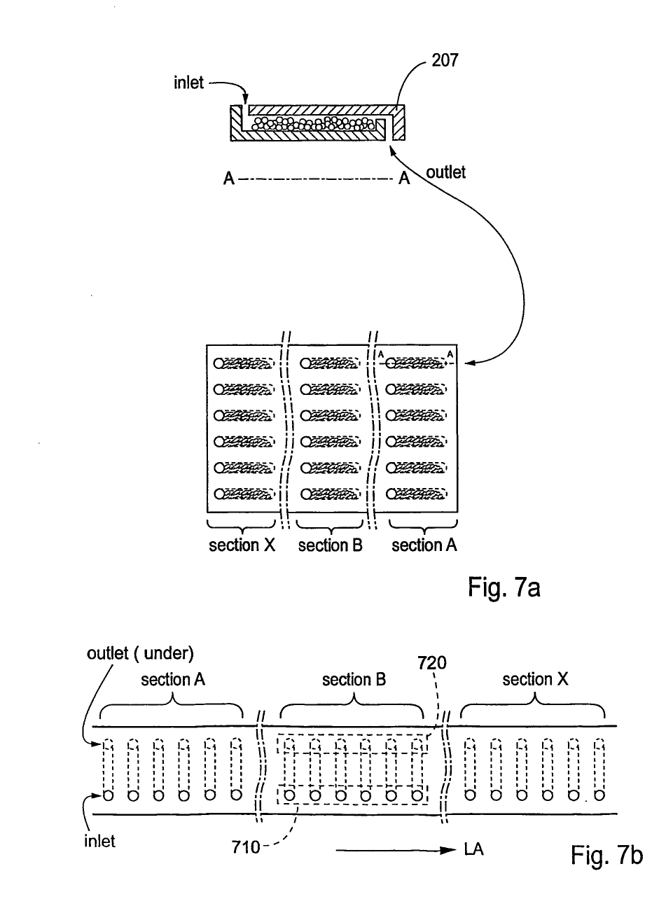

In FIG. 8 is shown another advantageous embodiment of a microextractor assembly comprising a circular disc or “daisy-wheel” arrangement where a number of sections A, B, C etc, each comprises a microextraction array to be positioned/docked to either a pipetting/filter paper device for loading and draining the microextraction array as described above, or docked to another type of loading/draining device, as outlined in FIG. 9.

Storage Function

The embodiments of the microextractor described above can also, with no, or just minor modifications be used as a storage unit, capable of retaining protein samples on the dockable microchip for long term storing e.g. at minus 20 degrees Celcius.

Electrospray

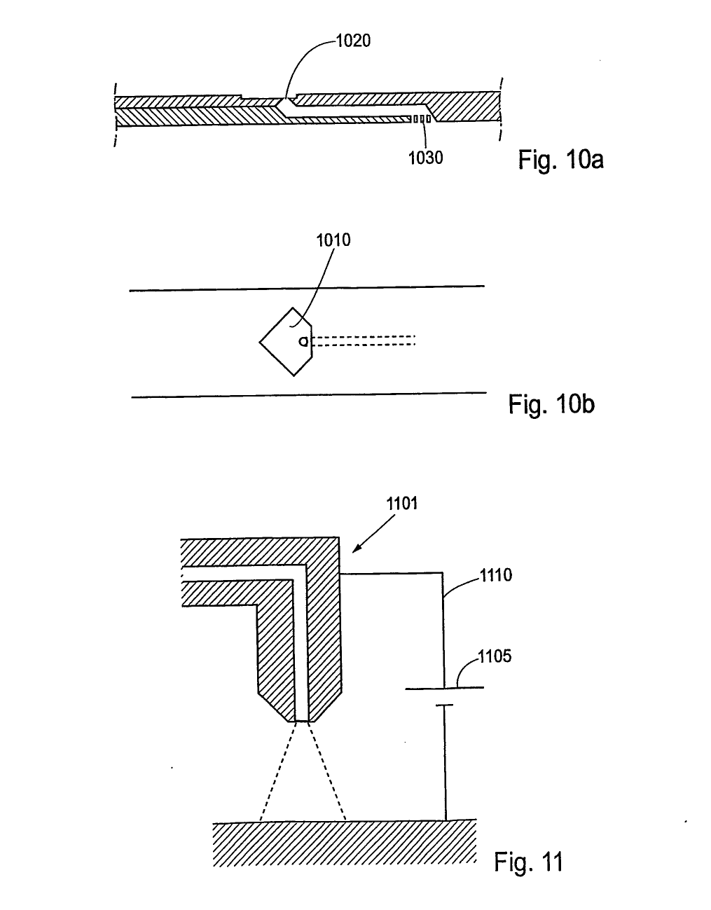

Referring to FIG. 11 an alternative embodiment of the invention comprises electrospray nozzles 101 as an alternative dispensing means, and corresponding electrical power source 1105 and circuitry 1110 instead of piezoelectric actuators and dispenser nozzles, making said dockable extraction chip compatible with tandem mass spectrometry using electrospray; or other type of ionisation.

Material

The device is preferably manufactured in polymer or silicon. A master for mass production of polymer devices is preferable made from metal or from a ceramic material. Silicon is essentially inert when dealing with protein mixtures at room- or near room temperature. The material is also very suitable for micro-machining techniques, e.g. for etching away parts of the material with established etching techniques.

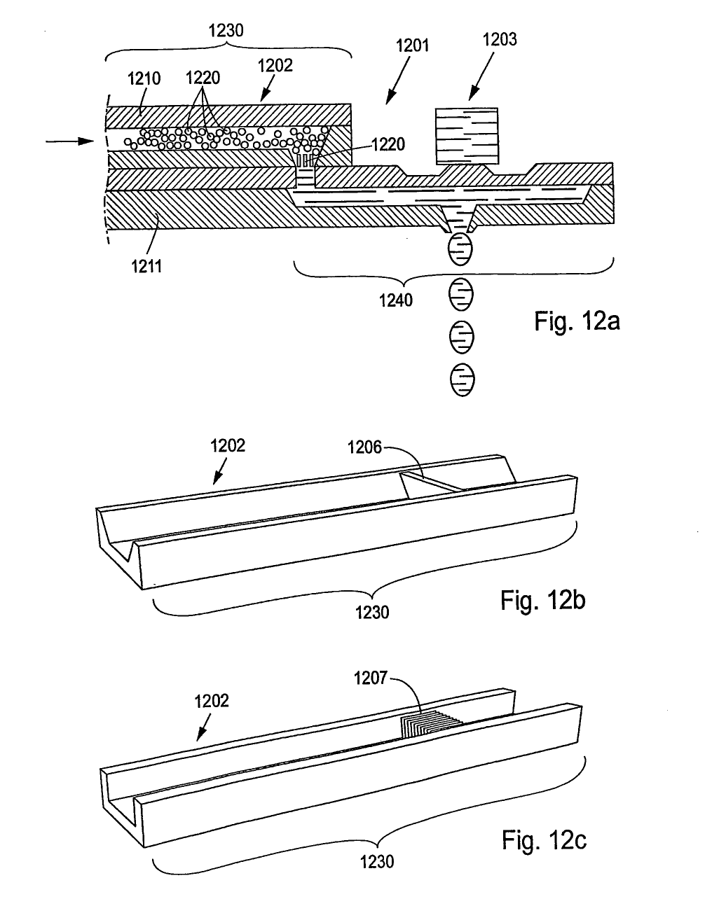

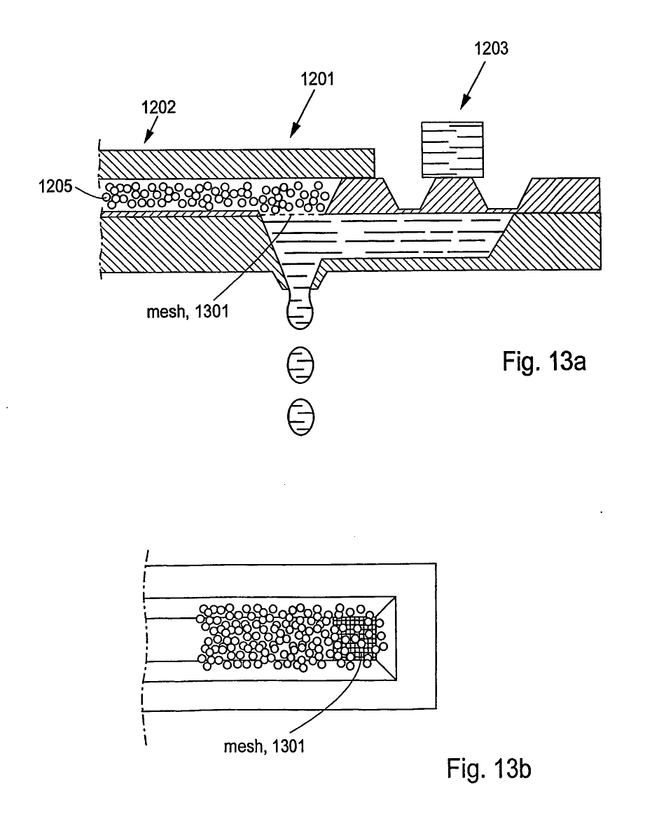

In FIG. 12a is shown a cross sectional view from the side of a combined extractor and dispenser. The extractor is provided with restraining means 1206, 1207 for preventing extraction beads 1220 from leaving the extractor portion 1230 and entering the dispenser portion 1240. Said restraining means can comprise a weir 1206 or a lattice 1207, said lattice comprising a number of erect thin walls separated by spaces smaller than the diameter of said beads 1220. Said restraining means can also comprise a mesh 1301 as indicated in FIG. 13.

Extraction Principles

Each of the aforementioned techniques can be performed by:

pressure driven or electrically driven devices or other suitable techniques.

Chromatographic separation utilising mechanisms of:

Chemical binding

i/Size exclusion—in samples where fractionation is required based upon size.

ii/Hydrophobic interactions—utilisation of reversed phase separation mechanisms whereby peptides and proteins will be separated by its hydrophobicity

iii/Polar interactions—silanol, and other types of polar functionalities readily interact with polar peptides/proteins and can be separated based upon polar chromatographic interactions.

Affinity Binding:

i/Chiral affinity—chiral small molecules may lend itself to be used as selective ligands for proteins/peptides to interact with whereby separations will be obtained.

ii/Metal affinity—Chelation by metal ion interaction of amine, and or carboxy-hydroxy functional groups, as well as Nickel ion-Histidine peptide residues, iron-, Gallium-ions and phosphate functionalities on peptides binds strongly.

Biochemical Bindings:

i/Antibody binding—Traditional biochemical bindings, antibody-antigen immunoaffinity bindings with both weak, medium and strong affinities having binding constants ranging from 10⁷ to 10⁹.
ii/Biotin avidin—affinity reagents utilising either Avidin or Biotin bound to peptides and either Avidin or Biotin on a solid support will selectively isolate peptides from complex sample mixtures due to the high affinity between Avidin/Biotin.
   Dispenser

As described above, a third operation is performed in a portion of said device immediately following the second one where each separate flow of eluate is conducted to a dispenser nozzle. Said nozzles being arranged beside each other forming a dispenser nozzle array.

In an alternative embodiment the separating walls, separating the different fractions is omitted near the dispenser nozzles. Components/fractions are held separated in different laminar flow portions of the flowing liquid due to the arranged speed of flow, and due to a design that promotes laminar flow. Diffusion is kept to a minimum because of the relative short time period/length which the liquid has to flow when not guided by separation walls/surfaces.

Target Plate

Said nozzle array is arranged to dispense microscopic amounts of said each separate flow of eluate to an array, i.e. to a row of wells in e.g. a 8×12 well plate. A control unit is provided that synchronises the action of the dispenser with the flow of mixture and flow of eluant. The stepwise movement of the well plate for a next row of wells to be placed in front (under) the dispenser array is also synchronised with the actions of the dispenser array.

The dispensing of droplets from the separate eluates is conducted in symphony with the evaporation of the eluant so that the amount of proteins deposited in the well can be increased over time by dispensing more droplets in the same well.

The well is provided with enzymes that, because of the small dimensions, controlled temperature and the high concentration of proteins, digest said proteins and form a high concentration of peptides.

A high concentration of peptide is favourable when performing a further chemical analysis by means of e.g. mass spectrometry.

The device is preferably manufactured in silicon. Silicon is essentially inert when dealing with protein mixtures at room- or near room temperature. The material is also very suitable for micro-machining techniques, e.g. for etching away parts of the material with established etching techniques.

Another advantage is that with said etching techniques the dimensions become very precise and it is possible to etch a surface with far better than micrometer precision.

1. A method useable for processing and depositing biomolecules, including the following steps:
receiving, in parallel a first set of analytes to be analysed;
passing each one of said analytes through extraction means where said biomolecules adhere to solid phase means;
washing said solid phase means with a washing liquid, leaving only said biomolecules;
performing elution by passing portions of organic solvent through each said solid phase, forming eluates constituting a second set of analytes containing said biomolecules, as a result of said elution;
conducting each one of said second set of analytes to a micro dispensing array;
dispensing precise amounts of each one of said second set of fractions on target areas of a target plate;
controlling the time between dispensing droplets from the dispenser;
controlling the temperature of the plate;
digesting said proteins into peptides by means of digestive enzymes being placed in the target areas.

2. The method as recited in claim 1, further comprising the step of controlling the time between the dispensing of said precise amounts such that analyte enrichment by emporation in each spot is provided.

3. The method as recited in claim 1, further comprising the step of controlling the temperature of the plate such that efficient evaporation is provided.

4. The method as recited in claim 1, further comprising the step of digesting said biomolecules into biomolecule fractions by means of digestive enzymes placed at target plate.

5. The method as recited in claim 4, further comprising the step of controlling the temperature of the plate such that a digestion speed of the digesting process is optimised.

6. The method as recited in claim 1, further comprising the step of mechanically moving the target plate so that a new row of target areas becomes available to the dispenser array.

7. The method as recited in claim 1, further comprises the steps of:
mechanically moving the target plate to a mass spectrometer;
performing mass spectrometry on each target area of the receiving plate, measuring peptide signatures;
recording said peptide signatures;
matching said measured peptide signatures to a library of peptide signatures for known proteins for determining the presence and content of different proteins in each target area.

8. The method as recited in claim 1, where said dispensing is performed using piezoelectric dispensing in array format.

9. The method as recited in claim 1 where said dispensing is performed using an electrospray method in array format.

10. An extraction device comprising at least two elongated channels or conduits, each conduit comprising a trench in a plate, each trench is separated from nearby trenches by means of a dividing wall; said device also comprises a sealing layer, serving as a sealant of said trenches, each of said conduits have a first and a second end with a first and a second port and being provided with a porous bed kept inside the conduit by means of a lattice means, said porous bed being provided with protein adhering units, said extraction device further comprising docking means that enables it to be removed from a feeding device and to be placed in contact with a washing device or an elution device.

11. The device as recited in claim 10, where said plate is a silicon plate, and said sealing layer is a glass layer, said layer being chemically bonded to said silicon plate.

12. The device as recited in claim 10, where said docking means comprises a polymer film preventing leakage to occur.

13. The device as recited in claim 10, where said docking means comprises a number of o-rings, preventing leakage to occur.

14. An extraction device comprising at least two elongated channels or conduits, each conduit comprising a trench in a plate, each trench is separated form nearby trenches by means of a dividing wall; said device also comprises a sealing layer, serving as a sealant of said trenches, each of said conduits have a first and a second end with a first and a second port and said conduits having porous walls or surfaces, said porous walls or surfaces being provided with biomolecule adhering units, said extraction device further comprises docking means that enables it to be removed from a feeding device and to be placed in contact with a washing device or an elution device.

15. The device according to claim 14 further comprising a dispenser comprising a dispenser nozzle, a basin, and a flexible membrane and a piezoelectric element arranged in line with the nozzle, said element being arranged to controllably depress the membrane and thereby cause the dispensing of a precise amount of liquid.

16. The device according to claim 11, wherein said dividing walls extend a part of the way to said dispenser.

17. The device according to claim 11, wherein said dividing walls extend all the way to said dispenser mechanically separating the flows from each conduit.

18. The device according to claim 14, provided with means for conducting sample transportation to a dispenser in a “step elution” in for instance three eluating solvents with varying eluating strengths.
